(19) United States
(12) Patent Application Publication
(10) Pub. No.: US 2002/0020088 A1
(43) Pub. Date: Feb. 21, 2002

(54) Packaging tape system and related process

(76) Inventor: Chris Kreutner, Canyon Country, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 09/934,777

(22) Filed: Aug. 21, 2001

Related U.S. Application Data
(60) Provisional application No. 60/226,990, filed on Aug. 21, 2000.

(51) Int. Cl. G09F 3/00

(52) U.S. Cl. 40/312

(57) ABSTRACT

A packaging tape system includes adhesive tape configured to extend across a face of a box and seal two flaps of the box in a closed position. Indicia is pre-printed on the adhesive tape and indicates a room or location in a house or office from which contents of the box originated. The adhesive tape is typically formed in dispensing rolls, each roll being of a distinctive color so as to be readily visually distinguishable from another roll for indicating another room or location within the house or office.

### RELATED APPLICATION

This application claims priority from provisional application Ser. No. 60/226,990, filed Aug. 21, 2000.

### BACKGROUND OF THE INVENTION

The present invention relates to moving supplies. More particularly, the present invention relates to pre-printed boxing tape which allows an individual to tape, label, and organize boxes in one convenient step.

When moving, it is desirable to pack boxes with articles and the like which are common to one another. For example, articles from a bedroom are preferably packed together as are articles from either the kitchen or garage. The advantage is that a box so packed can be completely unloaded in the corresponding area of the new house, for example master bedroom, instead of having to partially unload the box in one room and finish unpacking the box in another room. Also, kitchen items and food supplies, for example, can be safely packed with one another but may damage clothing from a bedroom or book from the living room.

Even when the boxes are packed according to room or living area, when unloading the boxes from the moving van it is impossible to remember which boxes should be placed in the rooms or areas the boxes belong. In this instance, it is not uncommon to place all of the boxes in a central room requiring the boxes to be moved to the bedroom, kitchen or garage as they are opened and the contents revealed. Moving requires constant bending and lifting of heavy items and placing the boxes in one central location for unpacking effectively doubles the physical toll and time involved.

Another option is to write the contents of the box or the room from which it was packed on the box itself. However, this process still presents problems as one has to direct people where to place the boxes in order to ensure that the boxes are in the correct room in the new home. At times, the handwriting is not legible or is too small to be seen at a distance. Oftentimes, the writing is smeared by other boxes or the movers themselves. Furthermore, if the boxes are intended to be used again, they must be packed according to the information previously written on them.

Also, when packing, it is not uncommon that two or more people are packing at the same time. Typically, there is only one marking pen and there may only be one roll of boxing tape. As boxes are packed, the pen and tape must be located or acquired from another person packing for sealing and identifying the contents of the box. In a multi-story home, this can become quite aggravating.

There exist moving labels which are often color coded to indicate where contents of a moving box or furniture originated within a house or office. However, a consumer must purchase these labels in addition to the boxing tape. Also, these labels are very small, typically only a few inches in length, rendering them difficult to read at a distance. Thus, several labels must be applied to each box so that a mover can determine where the box originated without having to look at every side of the box.

Accordingly, there is a need for a means of simplifying the labeling and organization of moving boxes. The present invention fulfils this need and provides other related advantages.

### SUMMARY OF THE INVENTION

The present invention resides in a packaging tape system, and process of use, that simplifies the labeling and organization of moving boxes. The system generally comprises adhesive tape configured to extend across a face of a box and seal two flaps of a box in a closed position. Indicia is preprinted on the adhesive tape, which indicates the room or location in a house or office from which the contents of the box originated.

Typically, the adhesive tape is formed in a dispensing roll. Preferably, the system includes multiple dispensing rolls, each roll being of a distinctive color so as to be readily visually distinguishable from another roll for indicating another room or location within the house or office.

When the pre-printed indicia relates to the rooms and locations of a house, the indicia specifies at least one of a bedroom, a bathroom, a kitchen, a dining room, a living room, a garage, a storage room, an office, a study, a den, a family room or a utility room.

When the pre-printed indicia relates to the rooms and locations of an office, the indicia specifies at least one of a break room, a conference room, a file room, a reception area, an office, a computer or a department.

In use, a moving box having opposed open flaps is supplied. Articles to be moved are placed in the moving box. The flaps of the box are closed towards one another, and adhesive tape from a dispensing roll indicating the room or location from which the articles in the box were taken is applied substantially over the length of opposing edges of the closed flaps to hold the flaps in a closed position. In this manner, the moving box is sealed and labeled simultaneously.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a perspective view of pre-printed adhesive boxing tape embodying the present invention;

FIG. 2 is a perspective view of two dispensing rolls of adhesive boxing tape embodying the present invention;

FIG. 3 is a perspective view of a moving box having articles placed therein; and

FIG. 4 is a perspective view of the box of FIG. 3 being sealed with the boxing adhesive tape of the present invention.

### DETAILED DESCRIPTION OF THE PREFERRED EMBODIMENTS

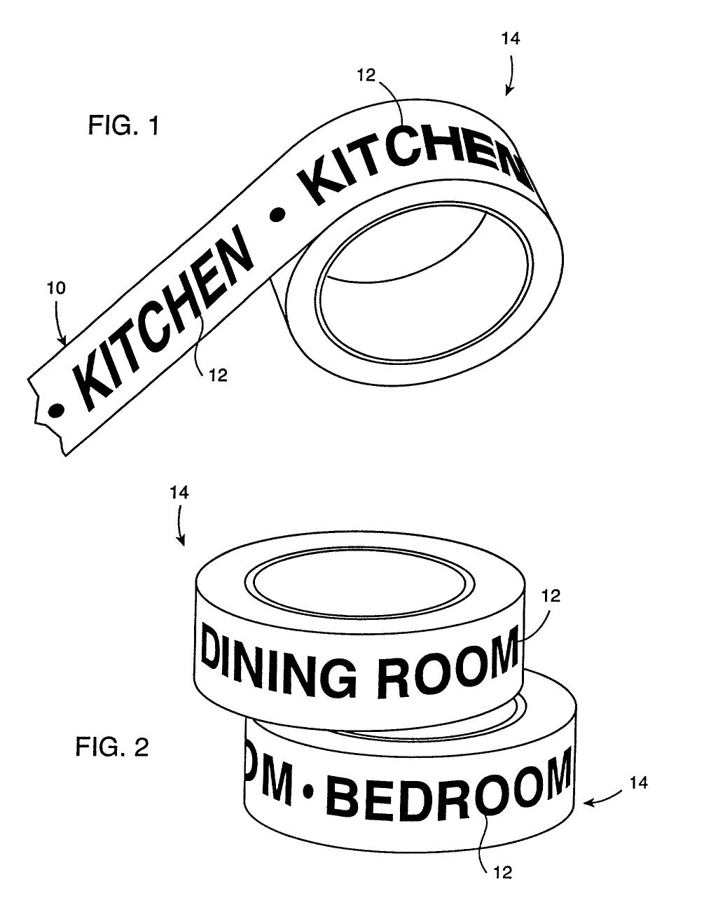

As shown in the drawings for purposes of illustration, the present invention is concerned with a packaging tape system comprising adhesive boxing tape 10 having pre-printed indicia 12 thereon for the purpose of labeling a packed moving box according to the room, housing area, or office area from which the contents were retrieved. The adhesive boxing tape 10 is of a length sufficient to extend across a face of a box and seal two flaps of the box in a closed position. Preferably, the adhesive tape 10 is formed in a dispensing roll 14 in traditional fashion. In FIG. 1, the word “kitchen” is repeatedly imprinted onto the tape 10 indicating that the contents of the box contains items from the kitchen.

With reference to FIG. 2, the present invention can label any box from any room in the house, for example, kitchen, bedroom, bathroom, dining room, living room, garage, storage room, office, study, den, family room, utility room, etc. Each roll of tape 14 has indicia printed repeatedly in sequence on the tape 10 which indicates the room from which the contents of the box originated, in the case of FIG. 2 “dining room”, and “bedroom”. The pre-printed indicia 12 can also relate to rooms and locations of an office, such as a break room, a conference room, a file room, a reception area, an office, a computer room or department.

The tape 10 can include indicia 12 which would distinguish one room or area from another similar room or area. For example, to distinguish various bedrooms from one another, each roll of tape 14 can have a number as part of the indicia 12, such as “bedroom No. 2”. However, in a preferred embodiment of the invention, each roll of boxing tape 14 is brightly colored (e.g. red, blue, orange, yellow, green, etc.). The indicia 12 is printed in a color which contrasts with the underlying color, for example black, and which indicates the specific room or area of the house for which it is to be used. For example, a roll of boxing tape 14 may be colored red and imprinted with the word “garage” in large black letters. The roll of tape 14 would be used to seal the contents of boxes containing articles from the garage. Different colored tape can be used to identify different rooms with the same description, such as more than one bedroom or bathroom. For example, a box taped with blue bedroom tape can be clearly distinguished from a box taped with yellow bedroom tape. It is contemplated that a professional moving company could also utilize contrasting colors to distinguish one mover's property from anothers which may be placed in the same moving van, or storage area.

It is also contemplated that roles of tape bearing the word “fragile”, or “open first” be produced. Thus, those boxes from which ever room of the house or office having fragile articles therein can be also taped with the roll of tape bearing the repeated word “fragile”. Alternatively, a small portion of the tape can be cut and placed on one or more sides of the box. Similarly, it is not uncommon that certain boxes should be opened before others. For example, those containing perishable items, items which need to be used in the first twenty-four hours after moving, such as towels, toiletries, cooking utensils, etc., can be labeled with the “open first” tape. This tape can either be clear, or color coated, as meets the requirements of the mover. Preferably, the invention is supplied as a kit which would include multiple rolls of tape so that a mover could purchase the kit and have at least one roll of tape for each room of the house, as well as the option of the “fragile” and “open first” rolls of tape. Of course, the rolls of tape embodying the present invention could be sold individually or in groups as deemed necessary.

The tape 10 can be comprised of any adhesive boxing tape which is sufficiently sturdy to meet the demands of moving the boxes. Such tape can include packing, carton tape, carton tape, cloth tape, polypropelene tape, masking tape, glass fiber tape, etc. The boxing tape 10 is preferably comprised of a carton sealing tape as the tape is easy to use, easy to remove, and strong enough to keep heavy items secure within a box. Carton sealing tape is also typically clear, and thus easy to add color and printing to the tape.

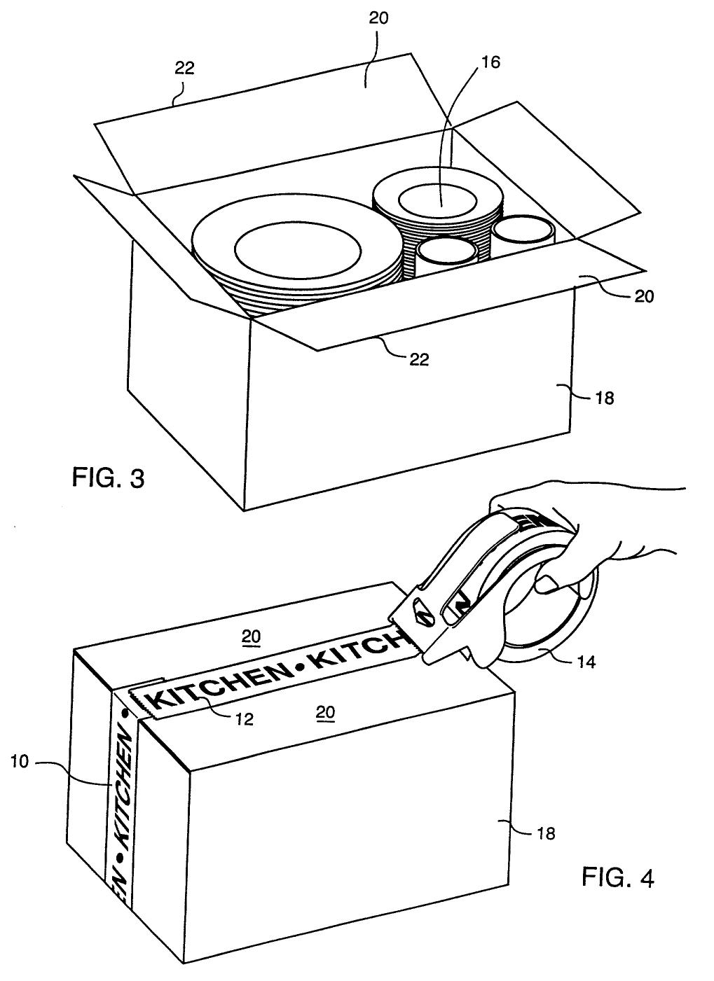

With reference now to FIGS. 3 and 4, when moving, articles 16 from one room or area of the house or office are typically placed within moving boxes 18. As illustrated in FIG. 3, plates and glasses from a kitchen area are shown within the moving box 18. Such moving boxes 18 have opposed open flaps 20 which are closed towards one another after the articles 16 have been placed within the box 18. The appropriate roll of tape 14 bearing the indicia 12 relating to the article 16 within the box 18 is selected and the tape 10 dispensed from the roll 14 and onto the box 18 so as to cover substantially the length of opposing edges 22 of the box flaps 20 in order to simultaneously seal and label the box 18. In typical fashion, the tape 10 extends from one end of the box, over the opposing flap edges 22, and onto the opposite end of the box in order to securely seal the box 18. This renders labeling on three sides of the box 18. The tape 10 can be applied to the box in a crisscross fashion (not shown) in order to more securely seal the box, while also labeling the sidewalls of the box 18 as well. In this fashion, the labeling indicia 12, and color of the tape 10, are visible from more than one surface of the box 18. Thus, those assisting in the move can clearly discern the color of the tape identifying indicia 12 at a distance from nearly every side of the box 18.

The tape 10 of the present invention can save a tremendous amount of time when unloading as the movers instantly know where the boxes 18 sealed with the tape 10 are to be placed. Corresponding tape 10 can be placed in the door jam, or on the carpet, of the room in which those boxes are to be placed. The boxes 18 sealed with the tape 10 of the present invention can also be loaded on to the moving truck in a much more organized fashion. As the printed indicia 12 on the tape is permanent, it will not smudge, smear or otherwise become illegible. Instead of throwing away the boxes 18 or scratching out old labels or markings, the tape 10 is simply removed from the boxes 18 and stored for later use. Excess tape 10 can also be saved and stored for subsequent moves, or when boxed items are placed in storage. The present invention also eliminates the need to purchase marking pens, labels and boxing tape to individually wrap and mark each box. The present invention conserves time, as well as money, as the steps of taping, labeling and marking the boxes is completed in a single step when the box is sealed with the tape 10 of the present invention.

Although several embodiments have been described in detail for purposes of illustrations, various modifications may be made without departing from the scope and spirit of the invention. Accordingly, the invention is not to be limited, except as by the appended claims.

What is claimed is:

1. A packaging tape system, comprising:
adhesive tape configured to extend across a face of a box and seal two flaps of the box in a closed position; and
indicia pre-printed on the adhesive tape indicating a room or location in a house or office from which contents of the box originated.

2. The system of claim 1, wherein the adhesive tape is formed in a dispensing roll.

3. The system of claim 2, comprising multiple dispensing rolls, each roll being of a distinctive color so as to be readily visually distinguishable from another roll for indicating another room or location within the house or office.

4. The system of claim 3, wherein the pre-printed indicia relating to the rooms and locations of the house specifies at least one of a bedroom, a bathroom, a kitchen, a dining room, a living room, a garage, a storage room, an office, a study, a den, a family room or a utility room.

5. The system of claim 3, wherein the pre-printed indicia relating to the rooms and locations of the office specifies at least one of a breakroom, a conference room, a file room, a reception area, an office, a computer or a department.

6. A packaging tape system, comprising:
multiple dispensing rolls of adhesive tape configured to extend across a face of a box and seal two flaps of the box in a closed position; and
indicia pre-printed on the adhesive tape indicating a room or location in a house or office from which contents of the box originated;
wherein each roll is of a distinctive color so as to be readily visually distinguishable from another roll indicating another room or location within the house or office.

7. The system of claim 6, wherein the pre-printed indicia relating to the rooms and locations of the house specifies at least one of a bedroom, a bathroom, a kitchen, a dining room, a living room, a garage, a storage room, an office, a study, a den, a family room or a utility room.

8. The system of claim 6, wherein the pre-printed indicia relating to the rooms and locations of the office specifies at least one of a breakroom, a conference room, a file room, a reception area, an office, a computer or a department.

9. A process for packaging articles to be moved, comprising the steps of:
supplying a moving box having opposed open flaps;
placing articles to be moved into the moving box;
closing the flaps toward one another; and
applying adhesive tape over substantially the length of opposing edges of the closed flaps to hold the flaps in a closed position, the adhesive tape having pre-printed indicia thereon indicating a room or location from which the articles were taken within a house or office, whereby the moving box is sealed and labeled simultaneously.

10. The process of claim 9, wherein the pre-printed indicia relating to the rooms and locations of the house specify at least one of a bedroom, a bathroom, a kitchen, a dining room, a living room, a garage, a storage room, an office, a study, a den, a family room or a utility room.

11. The process of claim 9, wherein the indicia relating to rooms and locations of the office specify at least one of a breakroom, a conference room, a file room, a reception area, an office, a computer or a department.

12. The process of claim 9, including the step of providing a dispensing roll of adhesive tape having pre-printed indicia thereon for indicating a room or location from which the articles were taken within a house or office.

13. The process of claim 9, including multiple dispensing rolls, wherein the adhesive tape of each roll is of a distinctive color so as to be readily visually distinguishable from another roll indicating another room or location of the house or office.

14. A process for packaging articles to be moved, comprising the steps of:
supplying a moving box having opposed open flaps;
placing articles to be moved into the moving box;
closing the flaps toward one another;
providing multiple dispensing rolls of adhesive tape having preprinted indicia thereon for indicating a room or location from which the articles were taken within a house or office, each roll being of a distinctive color so as to be readily visually distinguishable from another roll indicating another room or location of the house or office; and
applying adhesive tape from the dispensing roll indicating the room or location from which the articles within the box were taken over substantially the length of opposing edges of the closed flaps to hold the flaps in a closed position, whereby the moving box is sealed and labeled simultaneously.

15. The process of claim 14, wherein the pre-printed indicia relating to the rooms and locations of the house specify at least one of a bedroom, a bathroom, a kitchen, a dining room, a living room, a garage, a storage room, an office, a study, a den, a family room or a utility room.

16. The process of claim 14, wherein the indicia relating to rooms and locations of the office specify at least one of a breakroom, a conference room, a file room, a reception area, an office, a computer or a department.
